(19) United States
(12) Patent Application Publication
(10) Pub. No.: US 2005/0083450 A1
(43) Pub. Date: Apr. 21, 2005

(54) Lineraly polarized light separating film, linearly polarized light separating laminate film, backlight system and liquid crystal display

(75) Inventors: Hironori Motomura, Ibarakai-shi (JP); Minoru Kanatani, Ibaraki-shi (JP); Hiroyuki Takao, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi (JP)

(21) Appl. No.: 10/963,544

(22) Filed: Oct. 14, 2004

(30) Foreign Application Priority Data
Oct. 20, 2003 (JP) 2003-359402

(51) Int. Cl. G03B 21/00

(52) U.S. Cl. 349/96

(57) ABSTRACT

A linearly polarized light separating film comprising a linearly polarized light separating film and a hard coat layer, which is preferably a thickness in the range of from 1 to 6 μm, which is preferably formed with a resin coat layer having conductivity in which metal oxide fine particles are dispersed, on one side thereof, is good in scratch resistance, and in handleability.

### BACKGROUND OF THE INVENTION

1. Field of the Invention

The present invention relates to a linearly polarized light separating film suitable for an image display such as a liquid crystal display. The present invention further relates to a linearly polarized light separating laminate film laminating the linearly polarized light separating film and a linearly polarizing film. The present invention still further relates to a backlight system and to a liquid crystal display, which using the linearly polarized light separating film and the linearly polarized light separating laminate film.

2. Description of the Background Art

A linearly polarized light separating laminate film (B′) obtained, as shown in FIG. 4, by laminating a linearly polarized light separating film (1) and a linearly polarizing film (3) to each other is an optical element used in a state of being adhered to a liquid crystal cell in a transmission type liquid crystal display or the like. The linearly polarized light separating film (1) has a function that polarized light having the vibration plane in parallel to the transmission axis is transmitted therethrough with the vibration plane kept as is, while polarized light having the vibration plane in parallel to the reflection axis is reflected therein, wherein the transmission axis and the reflection axis are perpendicular to each other. The linearly polarizing film (3) has a function that polarized light having the vibration plane in parallel to the transmission axis is transmitted therethrough as is, while polarized light having the vibration plane in parallel to the absorption axis is absorbed therein, wherein the transmission axis and the absorption axis are perpendicular to each other. The linearly polarized light separation laminate film (B′) is, as shown in FIG. 6, disposed between an illuminator (backlight BL) of the transmission liquid crystal display and a liquid crystal cell (LC) and used for increasing brightness of the display screen.

The linearly polarized light separating film (1), however, has had the following problems. For example, the linearly polarized light separating film (1) is a film usually produced in a procedure in which a polyester-based resin is melted and extruded to a multi-layer film and then the film is transversely stretched. Therefore, the linearly polarized light separating film (1) itself is easy to suffer a scratch.

The linearly polarized light separating film (1) has another problem. For example, since the linearly polarized light separating film (1) is usually made of an insulating material such as a plastic, the film (1) is very easy to be electrically charged and the linearly polarized light separating film (1) is charged by peeling off a protective film therefrom or being brought into contact with the film. The charge causes a liquid crystal display to malfunction.

In order to cope with such a problem, a proposal has been made that an antistatic agent layer is formed on the linearly polarized light separating film (1) (see JP-A No. 2003-207633). According to JP-A No. 2003-207633, the problem related to charge can be solved. Ionic materials such as a cationic material and an anionic material used as an antistatic agent in the published patent application has a great influence on a conductivity in a humidified condition and unstable, and in addition, has a poor durability in a humidified environment at 60° C. and 90% R.H., for example, which has led a problem to easily cause whitening or cloudiness.

Since the linearly polarized light separating film (1) usually is, as described above, produced by melt extruding of a polyester-based resin, the film starts softening at 800 or higher in heating. As a result, in an ordinary liquid crystal display, the linearly polarized light separating film (1) is easily deformed on the surface thereof by being brought into contact with a light condensing film used ordinarily and the deformation has led to a problem to generate a defect in display of a liquid crystal display. The antistatic agent layer of JP-A No 2003-207633 has not solved such a problem.

### SUMMARY OF THE INVENTION

It is an object of the present invention to provide a linearly polarized light separating film good in scratch resistance. It is another object of this invention to provide a linearly polarized light separating film good in scratch resistance and excellent in handleability.

It is still another object of the present invention to provide a conductive linearly polarized light separating film having an antistatic effect, and excellent in durability together with the above described characteristics.

It is a further object of the present invention to provide a linearly polarized light separating laminate film laminating the linearly polarized light separating film and a linearly polarizing film to each other. It is a still further objet of this invention to provide a backlight system and to provide a liquid crystal display, using the linearly polarized light separating film or the linearly polarized light separating laminate film.

The present inventors have conducted serious studies in order to solve the above tasks with the resulted findings that the above objects can be achieved with a linearly polarized light separating film described below, which has led to completion of the present invention.

That is, the present invention relates a linearly polarized light separating film comprising a linearly polarized light separating film and a hard coat layer on one side thereof.

In the present invention, a scratch resistance can be imparted to the linearly polarized light separating film by formation of the hard coat layer. The hard coat layer can be formed as a coat good in scratch resistance even in heating. Such a hard coat layer can be imparted with a hardness to prevent deformation of the surface in heating. The hard coat layer can impart durability in a humidified state. Since a linearly polarized light separating film of this invention has, in this way, a hard coat layer, a scratch caused by a prism sheet (light condensing sheet) can be prevented even in heating test or the like.

In the linearly polarized light separating film, a thickness of the hard coat layer is preferably in the range of from 1 to 6 μm. A linearly polarized light separating film of the present invention can be imparted with scratch resistance by the hard coat layer, whereas a problem occurs that the linearly polarized light separating film is easy to be torn along a transverse direction in which stretching is applied due to formation of the hard coat layer. When a linearly polarized light separating film on which the hard coat layer is formed is bent with the hard coat layer located on the outer side (on the convex side), a problem arises that cracking occurs in the hard coat layer with ease. Since with decrease in the bending radius, breakage occurs in the linearly polarized light separating film, handleability is insufficient. Such a problem is solved in this invention by adopting a hard coat layer having a thickness in the range of 1 to 6 μm. With a thickness of the hard coat layer controlled in the range, generation of cracking in the hard coat layer can be prevented even in a case where the linearly polarized light separating film is bent. Furthermore, breakage of the linearly polarized light separating film can be prevented. A linearly polarized light separating film of this invention is in this way excellent in bendability and handleability. If a thickness of the hard coat layer exceeds 6 μm, an effect of the hard coat layer is enhanced, whereas bendability is lowered to thereby generate cracking with ease when being bent. On the other hand, if a thickness of the hard coat layer is less than 1 μm, bendability is good, while the effect of the hard coat layer is weakened (a pencil hardness and scratch resistance are reduced). In order to achieve compatibility between a hardness and bendability of the hard coat layer, a thickness of a hard coat layer is in the range of from 1 to 6 μm and preferably in the range of from 1.5 to 4 μm.

A linearly polarized light separating film of the present invention preferably generates no cracking in a hard coat layer even in a case where the film is wound on a rod having a circular section of a diameter of 6 mm with the hard coat layer located on the outer side as convex side. This shows a good bendability of the linearly polarized light separating film.

In a linearly polarized light separating film of the present invention, the hard coat layer is preferably a conductive hard coat layer. The conductive hard coat layer has scratch resistance provided by the hard coat layer itself and an antistatic property in addition to the handleability.

In the conductive linearly polarized light separating film, the conductive hard coat layer is preferably formed with a resin coat layer in which metal oxide fine particles are dispersed.

An antistatic function can be imparted with a conductive material, whereas the following inconvenience occurs with a material adopted other than metal oxide fine particles. For example, in a case where an ionic material (such as an anionic material, a cationic material, a nonionic material or the like) described in JP-A No. 2003-207633 is used as an antistatic agent, a problem arises in connection with durability and scratch resistance in heating as described above. In a case where a conductive polymer (such as polyaniline, polythiophene or the like) is used as an antistatic agent, a problem also arises in connection with scratch resistance in heating. A conductive polymer is insufficient in transparency, which exerts an adverse influence against brightness enhancement as a feature of a linearly polarized light separating laminate film. No problem occurs that is related to durability and scratch resistance in heating in the hard coat layer imparted with an antistatic effect using metal oxide fine particles and formed with a resin coat layer.

In the linearly polarized light separating film, a transmittance of the hard coat layer is preferably 80% or more. If the transmittance is less than 80%, it is not preferable in the aspect of brightness enhancement, which is a feature of the linearly polarized light separating film. The transmittance is preferably 80% or more and more preferably 85% or more.

The present invention relates to a linearly polarized light separating laminate film in which a linearly polarizing film is laminated on the side, on which no hard coat layer is formed, of the linearly polarized light separating film.

The present invention further relates to a linearly polarized light separating laminate film obtained by laminating a retardation plate on the linearly polarizing film of the linearly polarized light separating laminate film.

The present invention relates to a backlight system obtained by disposing at least a light source on the linearly polarized light separating film or the linearly polarized light separating laminate film.

The present invention relates to a liquid crystal display in which at least a liquid crystal is disposed in the backlight system.

A linearly polarized light separating film of the present invention is good in handleability and can be used by laminating a linearly polarizing film and in addition, an optical element such as a retardation plate and others thereon. Since a linearly polarized light separating film of this invention has a hard coat layer and in addition, a conductive hard coat layer, the film can be used for brightness enhancement in a backlight system or a liquid crystal display without degrading a display quality on a liquid crystal panel because of softening of the film or charge therein.

### BRIEF DESCRIPTION OF THE DRAWINGS

FIG. 1 is an example of a sectional view of a conductive linearly polarized light separating film (A) of the present invention.

FIG. 2 an example of a sectional view of a linearly polarized light separating laminate film of the present invention.

FIG. 3 is an example of a sectional view of linearly polarized light separating laminate film of the present invention.

FIG. 4 is an example of a sectional view of a conventional linearly polarized light separating laminate film.

FIG. 5 is an example of a sectional view of a liquid crystal display of the present invention.

FIG. 6 is an example of a sectional view of a conventional liquid crystal display.

### DESCRIPTION OF THE PREFERRED EMBODIMENTS

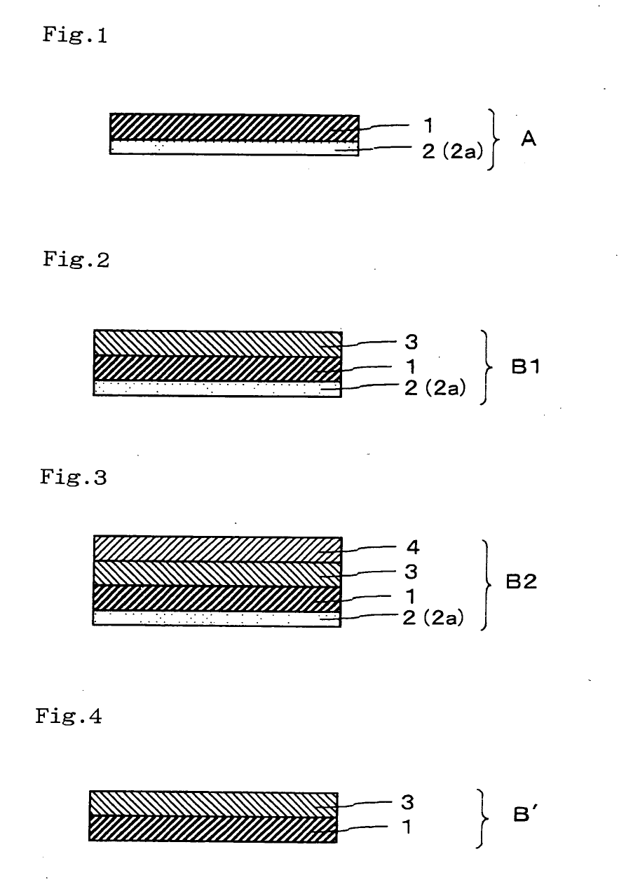

Description will be given of the present invention below with reference to the accompanying drawings. FIG. 1 is a sectional view of a linearly polarized light separating film (A) of this invention, wherein a hard coat layer (2) is provided on one side of a general linearly polarized light separating film (1). The hard coat layer (2) can be replaced with a conductive hard coat layer (2a).

FIG. 2 is a sectional view of a linearly polarized light separating laminate film (B1) and a linearly polarizing film (3) is laminated to the side, on which neither the hard coat layer (2) nor (2a) is formed, of the linearly polarized light separating film (1) of the linearly polarized light separating film (A) shown in FIG. 1. The linearly polarizing film (3) is laminated to the linearly polarized light separating film (1) so that the transmission axes are paralleled with each other. FIG. 3 is a sectional view in a case where a retardation plate (4) is laminated to the linearly polarizing film (3) in the linearly polarized light separating laminate film (B) of FIG. 2.

Examples of the linearly polarized light separating film (1) includes: a grid type polarizer; a multilayer thin film laminate with two layers or more, made of respective two or more kinds of materials having different refractive indexes; a vapor-deposited multilayer thin film having layers different in refractive indexes from each other used in a beam splitter or the like; a multi-birefringence layer thin film laminate with two layers or more, made of respective two or more kinds of material having different birefringence values; a stretched resin laminate with two layers or more, made of respective two or more kinds of resins having different refractive birefringence values; and a film separating by reflection or transmission of a linearly polarized light in axis directions perpendicular to each other.

As examples of the linearly polarized light separating film (1), there can be used a uniaxially stretched film of a multilayer laminate obtained by alternately laminating a material revealing a retardation by stretching, represented by a polyethylene naphthalate, polyethylene terephthalate and polycarbonate; and a resin low in retardation revelation such as an acrylic-based resin represented by poly(methyl methacrylate), and a norbornene-based resin and others represented by Arton manufactured by JSR CO., LTD. Used as concrete examples of the linearly polarized light separating film (1) is DBEF manufactured by 3 M Co. and others. A thickness of the linearly polarized light separating film (1) is usually on the order in the range of 50 to 200 μm.

The hard coat layer (2) can be formed with a resin coat layer. A resin material of which the resin coat layer is made may be any material as far as it has a sufficient strength and is transparent as a coat after formation of a resin coat layer without any specific limitation imposed. Examples of the resin includes: a thermosetting resin; a thermoplastic resin; an ultraviolet curing resin; an electron beam curing resin; a two part mixed resin; and others, among which preferable is a ultraviolet curing resin with which the hard coat layer can be efficiently formed through a simple processing operation in a curing treatment of illumination with ultraviolet. Examples of the ultraviolet curing resin includes: various kinds of resins such as polyester-based resin, acrylic-based resin, urethane-based resin, amide-based resin, silicone-based resin and epoxy-based resin, in which a monomer, an oligomer, a polymer and the like of an ultraviolet curing type are included. Ultraviolet curing resins preferably used includes: for example, a monomer, an oligomer or the like having an ultraviolet polymerizable functional group, among which preferable are resins including acrylic-based monomer and oligomer having two or more, especially 3 to 6 ultraviolet polymerizable functional groups as components. An ultraviolet polymerization initiator is mixed in an ultraviolet curing resin.

No specific limitation is imposed on a forming method for a resin coat layer and any proper method can be adopted. For example, a resin (in a coating liquid) described above is coated on a linearly polarized light separating film (1) to dry the wet coat. In a case where a curing resin is used, the dry coat is subjected to a curing treatment. Coating methods using the coating liquid that can be adopted are as follows: fountain coating, die coating, casting, spin coating, fountain metering coating, gravure coating and the like. In coating, the coating liquid may be diluted with ordinary solvents such as toluene, ethyl acetate, butyl acetate, methyl ethyl ketone, methyl isobutyl ketone, isopropyl alcohol, ethyl alcohol and others, or can be used as is without dilution.

The conductive hard coat layer (2a) can be formed, for example, with a resin coat layer in which metal oxide particles are dispersed. While materials each used for forming a resin coat layer is similar to those describe above, a selected material requires that metal oxide fine particles can be dispersed therein.

Exemplified as metal oxide fine particles are fine particles of ITO, ATO, tin oxide, antimony oxide, calcium oxide, indium oxide, cadmium oxide and others. Phosphorus or the like can be doped into a metal oxide particle. The metal oxide fine particles usually has preferably an average particle diameter of about 0.1 μm or less from the viewpoint of transmittance. The average particle diameter is preferably 0.08 μm or less and more preferably 0.06 μm or less. In the other aspects, carbon fine particles as conductive filler, and fine particles of gold and silver can be added together with the metal oxide fine particles.

Formation of the conductive hard coat layer (2a) can be conducted adopting methods similar to those described above except for use of a coating liquid in which metal oxide fine particles are dispersed. A proportion of metal oxide fine particles included in a coating liquid is not specifically limited and properly determined in consideration of an antistatic effect or the like. The proportion is usually preferably in the range of from 10 to 1000 parts by weight and more preferably in the range of from 20 to 100 parts by weight relative to 100 parts by weight of a resin described above.

A thickness of the hard coat layer (2) or the conductive hard coat layer (2a) are not specifically limited and generally on the order in the range of from 0.5 to 15 μm, preferably in the range of from 0.8 to 10 μm, and more preferably in the range of from 1 to 7 lm. In order to establish compatibility between the hardness and bendability of the hard coat layer, which is described above, a thickness of the hard coat layer (2) or the conductive hard coat layer (2a) is preferably in the range of from 1 to 6 μm and more preferably in the range of from 1.5 to 4 μm.

The linearly polarizing film (3) is usually called a polarizing plate and generally used in the form of a composite in which a protective film is provided on one side or both sides of a polarizer.

A polarizer is not limited especially but various kinds of polarizer may be used. As a polarizer, for example, a film that is uniaxially stretched after having dichromatic substances, such as iodine and dichromatic dye, absorbed to hydrophilic high molecular weight polymer films, such as polyvinyl alcohol type film, partially formalized polyvinyl alcohol type film, and ethylene-vinyl acetate copolymer type partially saponified film; poly-ene type orientation films, such as dehydrated polyvinyl alcohol and dehydrochlorinated polyvinyl chloride, etc. may be mentioned. In these, a polyvinyl alcohol type film on which dichromatic materials such as iodine is absorbed and oriented after stretched is suitably used. Although thickness of polarizer is not especially limited, the thickness of about 5 to 80 μm is commonly adopted.

A polarizer that is uniaxially stretched after a polyvinyl alcohol type film dyed with iodine is obtained by stretching a polyvinyl alcohol film by 3 to 7 times the original length, after dipped and dyed in aqueous solution of iodine. If needed the film may also be dipped in aqueous solutions, such as boric acid and potassium iodide, which may include zinc sulfate, zinc chloride. Furthermore, before dyeing, the polyvinyl alcohol type film may be dipped in water and rinsed if needed. By rinsing polyvinyl alcohol type film with water, effect of preventing un-uniformity, such as unevenness of dyeing, is expected by making polyvinyl alcohol type film swelled in addition that also soils and blocking inhibitors on the polyvinyl alcohol type film surface may be washed off. Stretching may be applied after dyed with iodine or may be applied concurrently, or conversely dyeing with iodine may be applied after stretching. Stretching is applicable in aqueous solutions, such as boric acid and potassium iodide, and in water bath.

As the transparent protective film prepared on one side or both sides of the polarizer, materials is excellent in transparency, mechanical strength, heat stability, water shielding property, isotropy, etc. may be preferably used. As materials of the above-mentioned transparent protective film, for example, polyester type polymers, such as polyethylene terephthalate and polyethylenenaphthalate; cellulose type polymers, such as diacetyl cellulose and triacetyl cellulose; acrylics type polymer, such as poly methylmethacrylate; styrene type polymers, such as polystyrene and acrylonitrile-styrene copolymer (AS resin); polycarbonate type polymer may be mentioned. Besides, as examples of the polymer forming a protective film, polyolefin type polymers, such as polyethylene, polypropylene, polyolefin that has cyclo-type or norbornene structure, ethylene-propylene copolymer; vinyl chloride type polymer; amide type polymers, such as nylon and aromatic polyamide; imide type polymers; sulfone type polymers; polyether sulfone type polymers; polyether-ether ketone type polymers; poly phenylene sulfide type polymers; vinyl alcohol type polymer; vinylidene chloride type polymers; vinyl butyral type polymers; allylate type polymers; polyoxymethylene type polymers; epoxy type polymers; or blend polymers of the above-mentioned polymers may be mentioned as a. Films made of heat curing type or ultraviolet ray curing type resins, such as acryl based, urethane based, acryl urethane based, epoxy based, and silicone based, etc. may be mentioned as materials of the above-mentioned transparent protective film.

Moreover, as is described in Japanese Patent Laid-Open Publication No. 2001-343529 (WO 01/37007), polymer films, for example, resin compositions including (A) thermoplastic resins having substituted and/or non-substituted imido group is in side chain, and (B) thermoplastic resins having substituted and/or non-substituted phenyl and nitrile group in side chain may be mentioned. As an illustrative example, a film may be mentioned that is made of a resin composition including alternating copolymer comprising iso-butylene and N-methyl maleimide, and acrylonitrile-styrene copolymer. A film comprising mixture extruded article of resin compositions etc. may be used.

In general, a thickness of the protection film, which can be determined arbitrarily, is 500 μm or less, preferably 1 through 300 μm, and especially preferably 5 through 200 μm in viewpoint of strength, work handling and thin layer.

Moreover, it is preferable that the protective film may have as little coloring as possible. Accordingly, a protective film having a retardation value in a film thickness direction represented by Rth=[(nx+ny)/2−nz]xd of −90 nm through +75 nm (where, nx and ny represent principal indices of refraction in a film plane, nz represents refractive index in a film thickness direction, and d represents a film thickness) may be preferably used. Thus, coloring (optical coloring) of polarizing plate resulting from a protective film may mostly be cancelled using a protective film having a retardation value (Rth) of −90 nm through +75 nm in a thickness direction. The retardation value (Rth) in a thickness direction is preferably −80 nm through +60 nm, and especially preferably −70 nm through +45 nm.

As a protective film, if polarization property and durability are taken into consideration, cellulose based polymer, such as triacetyl cellulose, is preferable, and especially triacetyl cellulose film is suitable. In addition, when the protective films are provided on both sides of the polarizer, the protective films comprising same polymer material may be used on both of a front side and a back side, and the protective films comprising different polymer materials etc. may be used. Aqueous adhesives are used for adhesion processing of the above described polarizer and the protective film. As adhesives, isocyanate derived adhesives, polyvinyl alcohol derived adhesives, gelatin derived adhesives, vinyl polymers derived latex type, aqueous polyurethane based adhesives, aqueous polyesters derived adhesives, etc. may be mentioned.

A hard coat layer may be prepared, or antireflection processing, processing aiming at sticking prevention, diffusion or anti glare may be performed onto the face on which the polarizing film of the above described transparent protective film has not been adhered.

A hard coat processing is applied for the purpose of protecting the surface of the polarizing plate from damage, and this hard coat film may be formed by a method in which, for example, a curable coated film with excellent hardness, slide property etc. is added on the surface of the transparent protective film using suitable ultraviolet curable type resins, such as acrylic type and silicone type resins. Antireflection processing is applied for the purpose of antireflection of outdoor daylight on the surface of a polarizing plate and it may be prepared by forming an antireflection film according to the conventional method etc. Besides, a sticking prevention processing is applied for the purpose of adherence prevention with adjoining layer.

In addition, an anti glare processing is applied in order to prevent a disadvantage that outdoor daylight reflects on the surface of a polarizing plate to disturb visual recognition of transmitting light through the polarizing plate, and the processing may be applied, for example, by giving a fine concavo-convex structure to a surface of the protective film using, for example, a suitable method, such as rough surfacing treatment method by sandblasting or embossing and a method of combining transparent fine particle. As a fine particle combined in order to form a fine concavo-convex structure on the above-mentioned surface, transparent fine particles whose average particle size is 0.5 to 50 μm, for example, such as inorganic type fine particles that may have conductivity comprising silica, alumina, titania, zirconia, tin oxides, indium oxides, cadmium oxides, antimony oxides, etc., and organic type fine particles comprising cross-linked of non-cross-linked polymers may be used. When forming fine concavo-convex structure on the surface, the amount of fine particle used is usually about 2 to 50 weight parts to the transparent resin 100 weight parts that forms the fine concavo-convex structure on the surface, and preferably 5 to 25 weight parts. An anti glare layer may serve as a diffusion layer (viewing angle expanding function etc.) for diffusing transmitting light through the polarizing plate and expanding a viewing angle etc.

In addition, the above-mentioned antireflection layer, sticking prevention layer, diffusion layer, anti glare layer, etc. may be built in the protective film itself, and also they may be prepared as an optical layer different from the transparent protective film.

The retardation plate (4) is a proper retardation plate adapted for the purpose of use. Exemplified as retardation plates are birefringent films obtained by stretching films made of proper polymers such as polycarbonate, norbornene-based resin, polyvinyl alcohol, polystyrene, poly(methyl metacrylate), polypropylene and other poyolefins, and polyallylate and polyamide; a alignment film made of a liquid crystal material such as a liquid crystal polymer; and an alignment layer of a liquid crystal material supported by a film. A thickness of the retardation plate (4) is usually preferably in the range of from 0.5 to 200 μm and especially preferably in the range from 1 to 100 μm.

A retardation plate (4) is laminated on a polarizing plate as a viewing angle compensating film and used as a wide viewing angle polarizing plate. A viewing angle compensating film is a film for magnifying a viewing angle so as to enable an image to be viewed with relatively sharpness even in a case where a screen image of a liquid crystal display is viewed not in a direction normal to the screen but in a slightly oblique direction relative to the screen.

As such viewing angle compensating retardation plates, there are available, in addition thereto, a film having a birefringence obtained by a biaxially stretching treatment, a stretching treatment in two directions perpendicular to each other or the like and a biaxially stretched film such as an inclined alignment film. As inclined alignment film, for example, a film obtained using a method in which a heat shrinking film is adhered to a polymer film, and then the combined film is heated and stretched or shrinked under a condition of being influenced by a shrinking force, or a film that is oriented in oblique direction may be mentioned. The viewing angle compensation film is suitably combined for the purpose of prevention of coloring caused by change of visible angle based on retardation by liquid crystal cell etc. and of expansion of viewing angle with good visibility.

Besides, a compensation plate in which an optical anisotropy layer consisting of an alignment layer of liquid crystal polymer, especially consisting of an inclined alignment layer of discotic liquid crystal polymer is supported with triacetyl cellulose film may preferably be used from a viewpoint of attaining a wide viewing angle with good visibility.

Note that the retardation plate (4) is formed by laminating two or more kinds of retardation plates and thereby can control an optical property such as retardation. A retardation layer functioning as a λ/4 plate over a broad wavelength range such as two visible light regions can be obtained, for example, by superimposing a retardation layer functioning as a λ/4 plate for a monochromic light of a wavelength of 550 nm and a retardation layer having other retardation property, for example, a retardation layer functioning as a λ/2 plate.

(Lamination of Layers)

Lamination of the layers may be only superimposed on each other, while it is desirable to laminate layers with an adhesive agent or a pressure-sensitive adhesive agent from the view point of operability and light utilization efficiency. In that case, it is desirable that the adhesive agent or the pressure-sensitive adhesive agent is transparent, has no absorption in a visible light region, and has refractive indexes as close as possible to each other from the viewpoint of suppression of surface reflection. From such a viewpoint, for example, an acrylic-based pressure-sensitive adhesive agent or the like is preferably adopted. Procedures can be applied in which the layers each form a monodomain as an alignment film separately and sequentially laminated according to a method such as transfer to a light transmissive substrate, or alternatively, in which an adhesive layer is not provided, an alignment film is properly formed for alignment and the layers are sequentially formed.

To the layers and the adhesive agent layers or the pressure-sensitive adhesive agent layers, if necessary, particles can be further added for adjustment in diffusibility and impartation of isotropic scatterbility; and there can be further properly added an unltraviolet absorbent, an antioxidant, and a surfactant for the purposes to impart a leveling property or the like in film formation.

(Backlight System)

At least a light source (BL) is disposed on the linearly polarized light separating film (A) and the linearly polarized light separating laminate film (B: B1 or B2) to thereby enable a backlight system to be constructed. It is desirable to dispose a diffusion reflector plate on the lower side of a light guide plate that is a light source (on the other side of the light guide plate from a plane on which a liquid crystal cell is disposed). A main component of light reflected on a collimating film is an oblique incident component and regularly reflected on the collimating film to return toward the backlight direction. In this situation, if a regular reflectability on a reflecting plate in the rear face side is high, a reflection angle is retained to thereby disable light to be emitted in the front direction only to be lost light. Therefore, since a reflection angle of a reflected-back light is not retained, a diffusion reflector plate is desirably disposed in order to increase a scattering reflection component in the front direction.

A proper diffusing plate is desirably disposed between the linearly polarized light separating film (A) or the linearly polarized light separating laminate film (B) and the backlight source (BL). This is because obliquely coming-in and reflected light is scattered in the vicinity of the backlight guide plate, a part of which is caused to scatter in the vertically incident direction to thereby raise a light recycle efficiency. A diffusing plate can also be obtained by means of a method in which such as fine particles different in refractive index from that of a resin is incorporated in the resin in addition to a method using a surface unevenness shape. The diffusing plate may be inserted between the linearly polarized light separating film (A) or the linearly polarized light separating laminate film (B) and the backlight source, or adhered to the collimating film.

In a case where a liquid crystal cell adhered to the linearly polarized light separating film (A) or the linearly polarized light separating laminate film (B) is disposed in the vicinity of the backlight, there is an opportunity to generate a Newton ring in a clearance between a film surface and the backlight, while generation of a Newton ring can be suppressed by disposing a diffusing plate with a surface unevenness on the surface of the light guide plate side of the linearly polarized light separating film (A) or the linearly polarized light separating laminate film (B).

(Liquid Crystal Display)

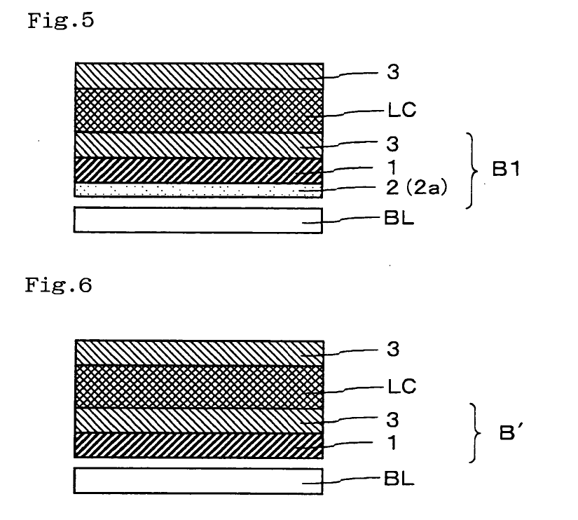

A liquid crystal display is produced according to an ordinary method, suitably using various kinds of optical layers and others. Polarizing plates are disposed on both sides, respectively, of a liquid crystal cell. The linearly polarized light separating film (A) or the linearly polarized light separating laminate film (B) is, as shown in FIG. 5, applied on the light source side of the liquid crystal cell. FIG. 5 is a sectional view in a case where the linearly polarized light separating laminate film (B) of FIG. 2 is applied to a liquid crystal display. The linearly polarizing film (3) is disposed on both sides, respectively; of the liquid crystal cell (LC) so that the transmission axes of both are perpendicular to each other. Note that in FIG. 5, the linearly polarized light separating laminate film (B2) of FIG. 3 can be used instead of the linearly polarized light separating laminate film (B1) of FIG. 2.

A liquid crystal display can be produced in conformity of a conventional method. That is, a liquid crystal display generally is formed by properly assembling constituents such as a liquid crystal cell, optical elements and an illuminator system when required and incorporating a driving circuit, which is in the manner taught traditionally, wherein no specific limitation is placed except that the linearly polarized light separating film (A) or the linearly polarized light separating laminate film (B) of the present invention is used. As to the liquid crystal, any type, for example, a TN type, an STN type and a π type can be adopted.

In production of a liquid crystal display, the following suitable constituents can be disposed in the construction: a diffusing plate, an antiglare layer, an antireflection film, a protective plate, a prism array, a lens array sheet, a light diffusing plate, a backlight and others, in respective proper positions in number of one or two of each of the constituents.

(Other Materials)

No specific limitation is, in addition to the above described condition, imposed on optical layers laminated when being actually used and there can be used one, or two or more optical layers that have an opportunity to be used in formation of a liquid crystal display and others, such as a reflection plate and a transflective plate. Examples thereof especially include: a reflection type polarizing plate and a transflective type polarizing plate obtained by laminating a reflection plate and a transflective plate, respectively, on an elliptic polarizing plate or a circular polarizing plate.

A reflective layer is prepared on a polarizing plate to give a reflection type polarizing plate, and this type of plate is used for a liquid crystal display in which an incident light from a view side (display side) is reflected to give a display. This type of plate does not require built-in light sources, such as a backlight, but has an advantage that a liquid crystal display may easily be made thinner. A reflection type polarizing plate may be formed using suitable methods, such as a method in which a reflective layer of metal etc. is, if required, attached to one side of a polarizing plate through a transparent protective layer etc.

As an example of a reflection type polarizing plate, a plate may be mentioned on which, if required, a reflective layer is formed using a method of attaching a foil and vapor deposition film of reflective metals, such as aluminum, to one side of a matte treated protective film. Moreover, a different type of plate with a fine concavo-convex structure on the surface obtained by mixing fine particle into the above-mentioned protective film, on which a reflective layer of concavo-convex structure is prepared, may be mentioned. The reflective layer that has the above-mentioned fine concavo-convex structure diffuses incident light by random reflection to prevent directivity and glaring appearance, and has an advantage of controlling unevenness of light and darkness etc. Moreover, the protective film containing the fine particle has an advantage that unevenness of light and darkness may be controlled more effectively, as a result that an incident light and its reflected light that is transmitted through the film are diffused. A reflective layer with fine concavo-convex structure on the surface effected by a surface fine concavo-convex structure of a protective film may be formed by a method of attaching a metal to the surface of a transparent protective layer directly using, for example, suitable methods of a vacuum evaporation method, such as a vacuum deposition method, an ion plating method, and a sputtering method, and a plating method etc.

Instead of a method in which a reflection plate is directly given to the protective film of the above-mentioned polarizing plate, a reflection plate may also be used as a reflective sheet constituted by preparing a reflective layer on the suitable film for the transparent film. In addition, since a reflective layer is usually made of metal, it is desirable that the reflective side is covered with a protective film or a polarizing plate etc. when used, from a viewpoint of preventing deterioration in reflectance by oxidation, of maintaining an initial reflectance for a long period of time and of avoiding preparation of a protective layer separately etc.

In addition, a transflective type polarizing plate may be obtained by preparing the above-mentioned reflective layer as a transflective type reflective layer, such as a half-mirror etc. that reflects and transmits light. A transflective type polarizing plate is usually prepared in the backside of a liquid crystal cell and it may form a liquid crystal display of a type in which a picture is displayed by an incident light reflected from a view side (display side) when used in a comparatively well-lighted atmosphere. And this unit displays a picture, in a comparatively dark atmosphere, using embedded type light sources, such as a back light built in backside of a transflective type polarizing plate. That is, the transflective type polarizing plate is useful to obtain of a liquid crystal display of the type that saves energy of light sources, such as a back light, in a well-lighted atmosphere, and can be used with a built-in light source if needed in a comparatively dark atmosphere etc.

Moreover, the polarizing plate may consist of multi-layered film of laminated layers of a polarizing plate and two of more of optical layers as the above-mentioned separated type polarizing plate. Therefore, a polarizing plate may be a reflection type elliptically polarizing plate or a transflective type elliptically polarizing plate, etc. in which the above-mentioned reflection type polarizing plate or a transflective type polarizing plate is combined with above described retardation plate respectively.

The elliptically polarizing plate or the reflection type elliptically polarizing plate is a laminate obtained by laminating a proper combination of a polarizing plate or a reflection type polarizing plate and a retardation plate, each kind alone or in number of two or more. Such an elliptically polarizing plate or the like can be produced by sequentially laminating (a reflection type) polarizing plate and a retardation plate in combination of both kinds as a pair or a set in a production process of a liquid crystal display, wherein an elliptically polarizing plate or the like in the form of an optical film obtained by lamination in advance has an advantage in that such an optical film is excellent in quality stability, lamination operability and others and can improve a production efficiency of a liquid crystal display or the like.

A pressure-sensitive adhesive layer or an adhesive layer can also be provided in an optical element of this invention. A pressure-sensitive layer can be used for adherence to a liquid crystal cell and in addition, is used in lamination of optical layers. In adherence of the optical film, the optical axis thereof can be set at a proper arrangement angle in adaptation for a retardation characteristic as a target.

As the pressure sensitive adhesive agent or the adhesive agent is not especially limited. For example, polymers such as acrylic type polymers; silicone type polymers; polyesters, polyurethanes, polyamides, polyvinyl ethers, vinyl acetate/vinyl chloride copolymers, modified polyolefines, epoxy type; and rubber type such as fluorine type, natural rubber, synthetic rubber may be suitably selected as a base polymer. Especially, the one which is excellent in optical transparency, showing adhesion characteristics with moderate wettability, cohesiveness and adhesive property and has outstanding weather resistance, heat resistance, etc. may be preferably used.

The pressure sensitive adhesive agent or the adhesive agent may contain cross-linking agent according to a base polymer. And the adhesive agent may contain additives, for example, such as natural or synthetic resins, adhesive resins, glass fibers, glass beads, metal powder, fillers comprising other inorganic powder etc., pigments, colorants and antioxidants. Moreover, it may be an adhesive layer that contains fine particle and shows optical diffusion nature.

An adhesive agent and a pressure-sensitive adhesive agent each are usually used as an adhesive agent solution of a base polymer or a composition thereof dissolved or dispersed in a solvent at a solid matter concentration of the order in the range of from 10 to 50 wt %. An organic solvent can be properly selected from the group consisting of toluene, ethyl acetate and others; water; or others, so as to be adapted for a kind of an adhesive agent for use.

An adhesive layer and pressure-sensitive adhesive layer may also be prepared on one side or both sides of a polarizing plate or an optical film as a layer in which pressure sensitive adhesives with different composition or different kind etc. are laminated together. Moreover, when adhesive layers are prepared on both sides, adhesive layers that have different compositions, different kinds or thickness, etc. may also be used on front side and backside of a polarizing plate or an optical film. Thickness of an adhesive layer may be suitably determined depending on a purpose of usage or adhesive strength, etc., and generally is 1 to 500 μm, preferably 5 to 200 μm, and more preferably 10 to 100 μm.

A temporary separator is attached to an exposed side of an adhesive layer to prevent contamination etc., until it is practically used. Thereby, it can be prevented that foreign matter contacts adhesive layer in usual handling. As a separator, without taking the above-mentioned thickness conditions into consideration, for example, suitable conventional sheet materials that is coated, if necessary, with release agents, such as silicone type, long chain alkyl type, fluorine type release agents, and molybdenum sulfide may be used. As a suitable sheet material, plastics films, rubber sheets, papers, cloths, no woven fabrics, nets, foamed sheets and metallic foils or laminated sheets thereof may be used.

In addition, in the present invention, ultraviolet absorbing property may be given to the above-mentioned each layer, such as a polarizer for a polarizing plate, a transparent protective film and an optical film etc. and an adhesive layer, using a method of adding UV absorbents, such as salicylic acid ester type compounds, benzophenol type compounds, benzotriazol type compounds, cyano acrylate type compounds, and nickel complex salt type compounds.

### EXAMPLES

Concrete description will be given of the present invention using examples.

### Example 1

DBEF manufactured by 3 M Co. was used as a linearly polarized light separating functional film. Coated on one side of DBEF was a coating liquid having a solid matter concentration of 25 wt % obtained by dispersing an acrylic-based hard coat resin (manufactured by DAINIPPON INK & CHEMICALS, Inc. with a trade name of UNIDIC 17-813) in isopropyl alcohol, and the wet coat was dried at 80° C. for 2 min and subjected to an ultraviolet treatment to thereby form a hard coat layer of 1.5 μm in thickness and obtain a linearly polarized light separating film.

### Examples 2 to 6

A linearly polarized light separating film was obtained by forming a hard coat layer in a similar way to that in Example 1 with the exception that in Example 1, a thickness of the hard coat layer was changed as shown in Table 1.

### Comparative Example 1

DBEF was used as it is, which was a linearly polarized light separating film without a conductive hard coat layer thereon.

### Example 7

DBEF manufactured by 3 M Co. was used as a linearly polarized light separating functional film. Coated on one side of DBEF was a coating liquid having a solid matter concentration of 25 wt % obtained by dispersing 30 parts by weight of metal fine particles (ATO: antimony containing tin oxide with an average particle diameter of 40 nm or less) and 70 parts by weight of an acrylic-based hard coat resin (manufactured by DAINIPPON INK & CHEMICALS, Inc. with a trade name of UNIDIC 17-813) in isopropyl alcohol, and the wet coat was dried at 80° C. for 2 min and subjected to an ultraviolet treatment to thereby form a conductive hard coat layer of 2.5 μm in thickness and obtain a linearly polarized light separating film.

### Example 8

A conductive linearly polarized light separating film was obtained by forming a conductive hard coat layer in a similar way to that in Example 7 with the exception that in Example 7, antimony oxide with an average particle diameter of 20 nm or less was used as metal fine particles.

### Example 9

A conductive linearly polarized light separating film was obtained by forming a conductive hard coat layer in a similar way to that in Example 7 with the exception that in Example 7, phosphorus doped tin oxide with an average particle diameter of 30 nm or less was used as metal fine particles.

### Example 10

DBEF manufactured by 3 M Co. was used as a linearly polarized light separating functional film. Coated on one side of DBEF was a coating liquid having a solid matter concentration of 25 wt % obtained by dispersing 30 parts by weight of metal fine particles (antimony oxide with an average particle diameter of 30 nm or less) and 70 parts by weight of an acrylic-based hard coat resin (manufactured by DAINIPPON INK & CHEMICALS, Inc. with a trade name of UNIDIC 17-813) in isopropyl alcohol, and the wet coat was dried at 80° C. for 2 min and subjected to an ultraviolet treatment to thereby form a conductive hard coat layer of 3 μm in thickness and obtain a conductive linearly polarized light separating film.

### Example 11

DBEF manufactured by 3 M Co. was used as a linearly polarized light separating functional film. Coated on one side of DBEF was a coating liquid having a solid matter concentration of 25 wt % obtained by dispersing 1 part by weight of a cationic material (manufactured by NOF CORP. with trade name of ELEGAN T-1100TM) and 99 parts by weight of an acrylic-based hard coat resin (manufactured by DAINIPPON INK & CHEMICALS, Inc. with a trade name of UNIDIC 17-813) in isopropyl alcohol, and the wet coat was dried at 80° C. for 2 min and subjected to an ultraviolet treatment to thereby form a hard coat layer of 3 μm in thickness and obtain a conductive linearly polarized light separating film.

### Comparative Example 2

A conductive linearly polarized light separating film was obtained in a procedure similar to that in Example 7 with exception that in Example 7, a coating liquid having a solid matter concentration of 25 wt % obtained by dissolving a conductive polymer (polyaniline) into isopropyl alcohol is coated, the wet coat is dried at 80° C. for 2 min to thereby form a conductive layer of 3 μm in thickness in place of forming a conductive hard coat layer.

The following evaluations were conducted on the linearly polarized light separating films having been obtained in the examples and the comparative examples. The results of the evaluations are shown in Table 1.

(Transmittance)

A transmittance of a hard coat layer was measured on a hard coat layer produced by applying a coating liquid similar to that as described above on a polyethylene terephthalate (PET) film separately from the examples and the comparative examples in the similar conditions to those as described above. In the evaluation, measurements were conducted on a transmittance (A) of a PET film before coating and a transmittance (B) of a PET film having a hard coat layer after coating. The transmittance values (B) are shown in Table 1. The transmittance (B) is a value relative to the transmittance (A) set to 100%. No measurement was conducted on Comparative Example 1. Note that a transmittance measuring instrument was a spectrophotometer (manufactured by Hitachi, Ltd. with a model No. of U4100).

(Pencil Hardness)

A test sample was placed on a glass plate with a hard coat layer (DBEF in Comparative Example 1) face on the top side and a line was drawn on the hard coat layer with a pencil having a tip end in sliding contact therewith under a load of 500 g, wherein a hardness of the lead in the pencil was selected as one of various ranks, and a pencil hardness was determined with a hardness one rank lower than a scratch was occurred on the hard coat layer.

(Scratch Susceptibility)

A test sample was placed on a glass plate with a hard coat layer face on the top side and steel wool of # 0000 was reciprocated on the hard coat layer in sliding contact therewith 10 times under a load of 400 g imposed on the steel wool and thereafter, a state of scratch generation was visually observed and evaluated with the following ratings indicated with symbols:
O: almost no scratch is recognized
Δ: several scratches are recognized
x: great number of scratches are recognized
   (Bendability)

It is visually recognized whether or not cracking is generated in a hard coat layer when a film is wound on a rod having a circular section of a diameter φ with the hard coat layer on the outer side. Diameters in mm at which cracking is generated are shown in Table 1.

(Scratch Resistance)

A test sample was placed on a glass plate with a hard coat layer face on the top side and a prism sheet (manufactured by 3 M Co. with a trade name of BEFII) was placed thereon with the prism face opposed to the test sample and a load of 10 g/cm² was imposed thereon and the test sample was subjected to a heating test at 85° C. for 24 hr and it was observed whether or not a pattern of the prism sheet was transferred (scratches were generated on the hard coat layer surface).

(Durability)

A film was left in environments with a sequence of heating at 80° C., humidification at 60° C. and 90% R.H. and keeping at low temperature of −40° C. for 500 hr and thereafter a change in appearance was observed.

(Production of Linearly Polarized Light Separating Laminate Film)

A linearly polarizing film (manufactured by NITTO DENKO CORP. with a trade name of TEG1465DU) was adhered to one side surface (opposite a hard coat layer) of a linearly polarized light separating film or a conductive linearly polarized light separating film having obtained in the examples and the comparative examples described above with an acrylic-based pressure-sensitive adhesive agent interposed therebetween to thereby to form a linearly polarized light separating laminate film. A protective film (manufactured by NITTO DENKO CORP. with a trade name of PPF100T) was adhered to the linearly polarized light separating film side (the hard coat layer side). The obtained linearly polarized light separating laminate films had durability similar to those described above.

(Charge Time)

The obtained linearly polarized light separating laminate film, on the linearly polarizing film side thereof, was adhered to a liquid crystal cell with an acrylic-based pressure-sensitive adhesive agent interposed therebetween. Thereafter a protective film on the linearly polarized light separating film side was peeled off to thereby generate static electricity and an influence thereof on a panel was investigated. The results are shown in Table 1. The influence on the panel when static electricity was generated was evaluated in a procedure in which a charge was measured prior to generation of static electricity and then the protective film was peeled off to charge the sample and a time was measured that was spent till the charge amount is restored back to an initial charge amount.

(Lamination of Retardation plate)

A durability and a charge time were measured on a laminate obtained by laminating a retardation plate on the linearly polarizing film side of an obtained linearly polarized light separating laminate film with an acrylic-based pressure-sensitive adhesive agent. The result showed that the durability and the charge time were similar to those prior to the lamination of the retardation plate.

TABLE 1

| | thickness of | | | | | scratch | durability | | | |
|---|---|---|---|---|---|---|---|---|---|---|
| | hard coat | transmittance | Pencil | scratch | bendability | resistance | | | low | charge |
| | layer (μm) | (%) | hardness | susceptibility | (mm) | in heating | heating | humidification | temperature | time |
| Example 1 | 1.5 | 99 | HB | ∘ | 3 | ∘ | no problem | no problem | no problem | 15 min |
| Example 2 | 3 | 99 | HB | ∘ | 4 | ∘ | no problem | no problem | no problem | 15 min |
| Example 3 | 5 | 98 | HB | ∘ | 5 | ∘ | no problem | no problem | no problem | 15 min |
| Example 4 | 0.5 | 99 | B | Δ | 3 | ∘ | no problem | no problem | no problem | 15 min |
| Example 5 | 7 | 98 | HB | ∘ | 8 | ∘ | no problem | no problem | no problem | 15 min |
| Example 6 | 10 | 97 | HB | ∘ | 10 | ∘ | no problem | no problem | no problem | 15 min |
| Comparative | no | — | 6B | x | — | x | no problem | no problem | no problem | 20 min |
| Example 1 | treatment | | | | | | | | | |
| Example 7 | 2.5 | 96 | HB | ∘ | 3 | ∘ | no problem | no problem | no problem | 1 sec |
| Example 8 | 2.5 | 98 | HB | ∘ | 3 | ∘ | no problem | no problem | no problem | 1 sec |
| Example 9 | 2.5 | 97 | HB | ∘ | 3 | ∘ | no problem | no problem | no problem | 1 sec |
| Example 10 | 3 | 98 | HB | ∘ | 4 | ∘ | no problem | no problem | no problem | 1 sec |
| Example 11 | 3 | 98 | HB | ∘ | 4 | ∘ | no problem | whitening | no problem | 1 sec |
| Comparative | 3 | 76 | 3B | x | 3 | x | no problem | no problem | no problem | 2 sec |
| Example 2 | | | | | | | | | | |

1. A linearly polarized light separating film comprising a linearly polarized light separating film and a hard coat layer on one side thereof.

2. The linearly polarized light separating film according to claim 1, wherein a thickness of the hard coat layer is in the range of from 1 to 6 μm.

3. The linearly polarized light separating film according to claim 1, wherein no cracking is generated in the hard coat layer even in a case where the film is wound on a rod having a circular section of a diameter of 6 mm with the hard coat layer located on the outer side as convex side.

4. The linearly polarized light separating film according to claim 1, wherein the hard coat layer is a conductive hard coat layer.

5. The linearly polarized light separating film according to claim 4, wherein the conductive hard coat layer is formed with a resin coat layer in which metal oxide fine particles are dispersed.

6. The linearly polarized light separating film according to claim 1, wherein a transmittance of the hard coat layer is 80% or more.

7. A linearly polarized light separating laminate film comprising the linearly polarized light separating film according to claim 1 and a linearly polarizing film laminating on a side, on which no hard coat layer is formed, of the linearly polarized light separating film.

8. A linearly polarized light separating laminate film further comprising a retardation plate laminating to the linearly polarizing film of the linearly polarized light separating laminate film according to claim 7.

9. A backlight system comprising at least a light source and the linearly polarized light separating film according to claim 1.

10. A liquid crystal display comprising least a liquid crystal cell and the backlight system according to claim 9.

11. A backlight system comprising at least a light source and the linearly polarized light separating film according to claim 2.

12. A backlight system comprising at least a light source and the linearly polarized light separating film according to claim 3.

13. A backlight system comprising at least a light source and the linearly polarized light separating film according to claim 4.

14. A backlight system comprising at least a light source and the linearly polarized light separating film according to claim 5.

15. A backlight system comprising at least a light source and the linearly polarized light separating film according to claim 6.

16. A backlight system comprising at least a light source and the linearly polarized light separating laminate film according to claim 7.

17. A backlight system comprising at least a light source and the linearly polarized light separating laminate film according to claim 8.

18. A liquid crystal display comprising least a liquid crystal cell and the backlight system according to claim 11.

19. A liquid crystal display comprising least a liquid crystal cell and the backlight system according to claim 12.

20. A liquid crystal display comprising least a liquid crystal cell and the backlight system according to claim 13.

21. A liquid crystal display comprising least a liquid crystal cell and the backlight system according to claim 14.

22. A liquid crystal display comprising least a liquid crystal cell and the backlight system according to claim 15.

23. A liquid crystal display comprising least a liquid crystal cell and the backlight system according to claim 16.

24. A liquid crystal display comprising least a liquid crystal cell and the backlight system according to claim 17.
